(19) United States
(12) Patent Application Publication
(10) Pub. No.: US 2008/0241324 A1
(43) Pub. Date: Oct. 2, 2008

(54) Extrusion Apparatus and Method for Extruding High Protein Foodstuffs

(75) Inventors: Hans F. Bohner, Timaru (NZ); Kelly J. Reynolds, Timaru (NL)

Correspondence Address: KNOBBE MARTENS OLSON & BEAR LLP, 2040 MAIN STREET, FOURTEENTH FLOOR, IRVINE, CA, 92614, US

(73) Assignee: Fonterra IP Limited, Auckland (NZ)

(21) Appl. No.: 11/573,941

(22) PCT Filed: Aug. 19, 2005
(86) PCT No.: PCT/NZ05/00215

§ 371 Date: Jan. 8, 2008

(30) Foreign Application Priority Data
Aug. 20, 2004 (US) 10923514

(51) Int. Cl. A23P 1/12

(52) U.S. Cl. 426/451; 425/113

(57) ABSTRACT

There is described a twin-screw extruder in which there are provided a pair of die hole sets which are aligned with the extrusion paths from each screw. This arrangement allows all the extrusion path lengths from a plane perpendicular to the screw ends to the outer ends of the die holes to be substantially the same. Preferably two sets of cutter blades cut extrudate at the die hole outlets of each set. The blades are arranged on a pair of rotary assemblies, the axes of rotation of which are substantially coaxial with the axes of rotation of the extruder screws. Optionally a pressure chamber, capable of sustaining a pressure of less than ambient, is in gas tight communication with the outlet of the extruder to receive extrudate to enhance expansion of the extrudate.

### TECHNICAL FIELD

This invention relates to extruders. More particularly it relates to twin screw extruders which are suitable for the production of high protein foodstuffs having desirable sensory characteristics. The extruder of this invention may also be used for other applications.

### BACKGROUND ART

The technology to prepare expanded edible products for consumption as snacks or breakfast cereals, and other products has long been established. However, high protein mixes have a tendency to form tough, textured extruded products rather than light, crisp textures. High temperature extruders are capable of producing expanded food products, such as snacks and cereals. The expansion occurs when the moist dough exits from the high pressure environment inside the extruder to the low pressure environment outside. Superheated water at temperatures exceeding the boiling point instantly vaporize and expand, forming bubbles within the dough. The bubbles grow until the temperature of the dough pellet drops to the boiling point of water. The relationship between pressure and boiling point is well understood and data tables are published.

In the manufacture of predominantly starch based ready to eat breakfast cereals and snack foods, increased expansion at the die is typically achieved by increasing the temperature of the dough. Means for the temperature increase are well known, and are principally viscous dissipation of mechanical energy, thermal transfer from the walls of an extruder and introduction of steam either into a pre-conditioner or directly into the barrel of an extruder. High protein dough however, is susceptible to discolouration and increase in viscosity at elevated temperatures.

U.S. Pat. Nos. 4,935,183; 4,983,114; and 6,048,088 all describe twin screw extruders which can be used for extruding a high protein foodstuff extrudate. Each of the extruders described has a single die at the outlet end of its barrel. The bore within the extruder barrel of each of these has a pathway of reducing cross-sectional area in the extrusion zone leading up to the die. One application of such an extruder is shredded cereal production. Raw materials such as maize, rice, potato, wheat or other flours are mixed with proteins and vitamins and fed into the extruder along with moisture. The extruders described have twin co-rotating, self wiping screws which intermesh with one another.

A twin screw extruder is able to accomplish the cooking part of the process as the material is being advanced along the extruder in a manner which is quicker than that of a single screw cooking extruder. It is also better able to advance more viscous extrudates. A high protein food product is more viscous than a lower protein product.

In an extruder with a single screw, die holes that pass through a die plate at the end of the barrel are arranged so that where the distance from the screw end is about equal to each die exit hole. However, this is more difficult to achieve where there are twin screws but only a single die, and where the die holes are not aligned with all of the extrudate path. This results with viscous fluids, such as a high protein foodstuff extrudate, in a flow rate from the end of the screw to the different die holes being uneven, giving rise to a product of uneven texture.

It is an object of one aspect of this invention to go someway towards overcoming this problem or at least to offer the public a useful choice.

In addition to having a product of consistent texture it is desirable for a high protein product to expand sufficiently so that it is not too hard for consumer preference once it has cooled.

In WO 01/72153 and in U.S. Pat. No. 6,531,077 there are described extruders in which the rate of expansion of the extrudate is limited by extruding it into a pressure chamber where the pressure is maintained above ambient pressure. Super-atmospheric pressure would not be of assistance in the extrusion of high protein foodstuff extrudate because it would limit expansion.

It is an object of another aspect of this invention to overcome the above identified disadvantage, or at least to offer the public a useful choice.

### SUMMARY OF INVENTION

Accordingly the invention may be said broadly to consist in an extruder suitable for extuding an expanded high protein food extrudate which comprises:
a twin screw extruder having an elongate barrel with an inlet end, an outlet end and a pair of substantially frusto-cylindrical bores therealong,
a pair of flighted extrusion screws within the bores, the screws and bores defining an extrusion pathway therebetween from the inlet end to the outlet end of the barrel,
a pair of die hole sets, each set having a plurality of die holes therethrough mounted at the outlet end of the barrel, each die hole being aligned with a portion of the extrusion pathway,
the arrangement being such that the extrudate flow paths from the outlet ends of the extrusion screws to each of the outlets of end of the die holes is of substantially the same length.

In one embodiment the outlet ends of the twin screws are substantially adjacent the outlet ends of the die holes in an axial direction.

In another embodiment there are provided cutting means arranged to cut extrudate extruded from the die holes into discrete pieces.

In one embodiment the cutting means comprises a pair of cutting means, each one arranged to cut extrudate extruded from one of the die hole sets.

In another embodiment each of the pair of cutting means has at least one cutting blade mounted to rotate about an axis substantially co-extensive with the axis of rotation of one of the extrusion screws, and adjacent one of the die hole sets.

In another embodiment there is provided a gas tight chamber at the outlet end of the barrel in gas tight communication therewith, the gas pressure within the chamber being lower than the ambient pressure, so that extrudate extruded through the die holes is allowed to expand in the chamber.

In another embodiment the chamber is provided with a vacuum pump to reduce the pressure therein.

In another embodiment the chamber is provided with means to discharge extrudate without substantially raising the gas pressure therein.

In a further embodiment the discharge means is a rotary valve.

In an further embodiment there a provided means for keeping extrudate pieces separate from one another until they have cooled.

In another embodiment the invention is a process for extruding a high protein foodstuff which comprises feeding a dry mixture of a foodstuff with high protein content, water, and, where required, steam, into an extruder as defined above at the inlet end thereof and recovering an extrudate from the outlet and thereof.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

FIG. 1 is a side elevational view, in part truncated, of a barrel of an extruder according to the invention, having a reduced pressure chamber at its outlet in, a part of the pressure chamber wall being cut away.

FIG. 2 is a top plan view of the twin screws of an extruder of the invention with the top of the barrel removed.

FIG. 3 is a top view, partly in section, of the die housing mounted at the outlet end of the extruder barrel.

FIG. 4 is an end view, looking outwardly, of the die housing of FIGS. 3 and 5.

FIG. 5 is an end view, looking inwardly of the die housing illustrated in FIGS. 3 and 4.

FIG. 6 is a partial sectional view VI-VI of the die plate illustrated in FIG. 7.

FIG. 7 is an end view of the die plate looking outwardly from the extruder barrel outlet.

FIG. 8 is a schematic view of the two sets of cutter blade assemblies which cut extrudate emerging from the die holes in the die plate of FIG. 7.

FIG. 9 is a side elevational view of one of the cutter blade assemblies shown in FIG. 8.

### DETAILED DESCRIPTION OF THE DRAWINGS

Construction of Extruder

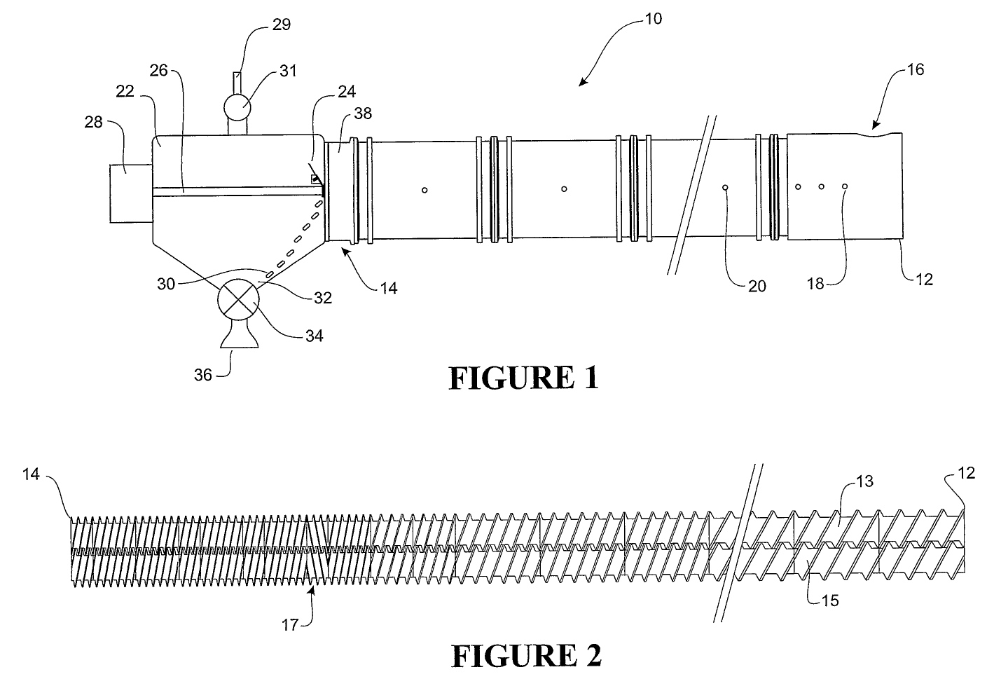

An extruder according to the invention has a barrel 10 with an inlet end 12 and an outlet end 14. As illustrated in FIG. 1, the barrel 10 has an opening 16 for feeding in dry material. Typically this will be connected with a hopper or other feeding device known in the art.

The barrel 10 also has a water input receiving connection 18 and a steam input receiving connection 20. These are connected with sources of water and steam and controlled by controlling mechanisms commonly known in the art.

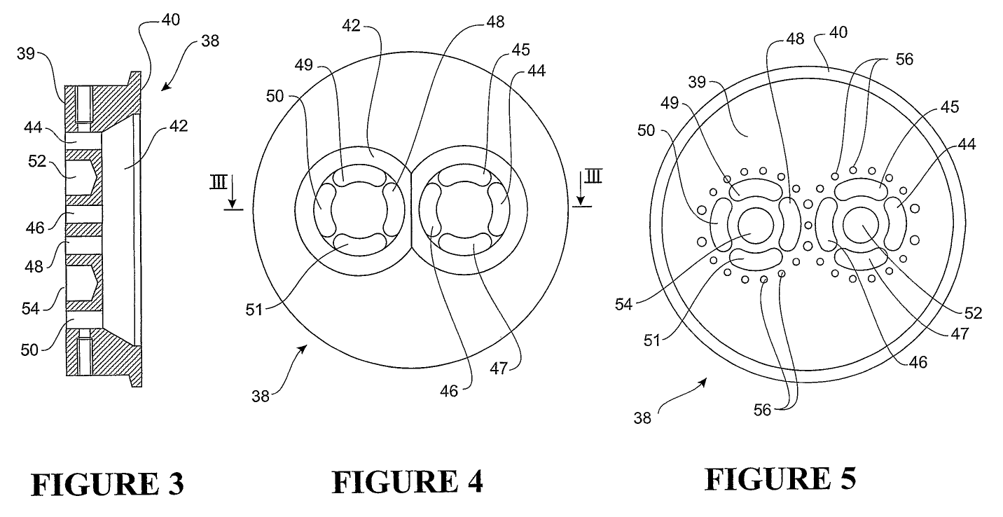

At the outlet end 14 of the barrel is mounted a die housing 38 which is described in more detail with reference to FIGS. 3 to 5.

A low pressure chamber 22 is joined in an gastight connection to the die housing 38. Passing through chamber 22 are a pair of shafts 26 which rotate spiders 70 which carry cutter blades 24. The construction and operation of the cutter blades will be described with reference to FIGS. 8 and 9.

Cut extruded product 30 drops from cutter blades 24 into the neck 32 of chamber 22. A rotary valve 34 is provided at the bottom of neck 32. Rotary valve 34 operates to transfer cut extruded product 30 from chamber 22 to mouth 36 without allowing any substantial increase in pressure within chamber 22 by air leaking it.

Valve 31 is connected to vacuum line 29. Vacuum line 29 is connected to a source of vacuum to reduce the pressure within chamber 22 to the desired level. Valve 31 may also be opened to atmosphere to restore the pressure in chamber 22 to ambient.

Referring to FIG. 2 the twin screws 13 and 15 co-rotate within a pair of frusto-cylindrical cores extending along the barrel 10. The screws are driven by motors to the right of the inlet end 12 of the barrel. The screws 13 and 15 are in replaceable segments mounted on two central shafts. This enables the operator to vary the screw profiles and resulting shear input according to product requirements. In the embodiment illustrated in FIG. 2 the pitch of the upstream segments is higher than that of the downstream segments. The segments with the lower pitch increase the shear. The segment 17 has a reverse pitch. This provides additional mixing of the extrudate. Alternative screw segment profiles that provide additional mixing are illustrated in U.S. Pat. No. 4,935,183 and U.S. Pat. No. 6,048,088. Other types are known to those skilled in the art.

It will be seen that the cross-sectional area of the bore within the barrel 10 remains substantially the same along its length from the inlet end 12 to the outlet end 14.

The die housing 38 will now be described with reference to FIGS. 3 to 5. The housing 38 has a body 39 with a flange 40 which is affixed to a flange at the outlet end 14 of barrel 10. The throat portion 42 is aligned with the outlet end 14 of barrel 10. Passages 44, 46, 48 and 50 are aligned with the extrudate path from screw 13. Passages 48, 49, 50 and 51 are aligned with the extrudate path from screw 15.

In the outside face of body 39 there are provided a pair of cylindrical shaft end seats 52 and 54. These are constructed to receive the shaft ends 66 of the cutter end assemblies illustrated in FIGS. 8 and 9.

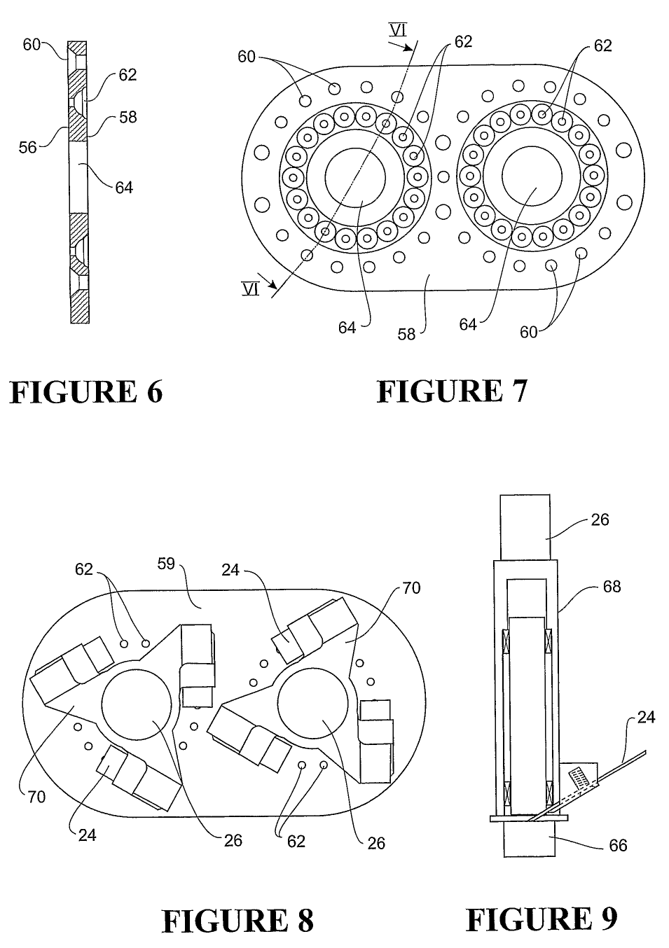

Referring to FIG. 5, there are provided a pair of intersecting circles of threaded bolt holes 56. These are provided to receive bolts to retain the die plate 58 illustrated in FIGS. 6 and 7.

Turning to FIGS. 6 and 7, die plate 58 has a pair of sets of die holes 62, each set being arranged substantially in circles which are aligned with the sets of passages 44, 46, 48 and 50; and 45, 47, 49 and 51; through die housing 38. These in turn are aligned with substantially annular flow paths of extrudate from each of the extruder screws 13 and 15.

The profile of each of the extrusion holes 62 is substantially hemispherical on the upstream side and substantially cylindrical at the downstream side in the embodiment shown. Die holes to produce extrudate of other desired shapes are well known in the art and could be substituted for the shapes illustrated here.

Bolt holes 60 pass through die plate 58. They are positioned to be in registry with threaded bolt holes 56 in die housing 38. Plate 58 is secured to the outer face of housing 38 with suitable bolts.

Also passing through die plate 58 are a pair of central openings 64 which are positioned to be in registry with shaft ends 66 of the cutter assembly and seats 52 and 54 in die housing 38.

Turning to FIGS. 8 and 9 the cutter assemblies comprise a pair of spiders 70 each mounted on a rotatable shaft 26. The rotational axes of shafts 26 are substantially coaxial with the rotational axes of screws 13 and 15. On each of the spiders 70 are mounted three cutter blades 24 positioned to rotate in registry with each of the two sets of die holes 62 on face 59 of die plate 58. The right hand cutter assembly illustrated in FIG. 8 is arranged to rotate in a counter-clockwise direction. The cutter assembly on the left side of FIG. 8 is arranged to rotate in a clockwise direction. The two are synchronised so that where their rotational paths overlap, a cutter blade 24 from one assembly does not collide with a cutter blade 24 from the other.

Referring FIG. 9, each blade 24 is mounted at an angle to the face 59 of die plate 58. Its position relative to the face of 59 of die 58 is adjustable. The shaft ends 66 are fitted through shaft openings 64 in die plate 58 to be press fitted into seats 52 and 54 of die housing 38. Shaft 26 is bearingly mounted in bearing 68 in any convenient arrangement known to those skilled in the art.

The shafts 26 of each of the cutter assemblies are driven by motor 28. The speed of rotation of shafts 26 can be controlled by either gears or by adjusting the rotational speed of the motor 28.

Operation of the Extruder

Typical high protein mixtures to be used to produce a high protein foodstuff extrudate are described in the examples. In operation, a dry mixture of material is fed into the opening 16 of the barrel 10. Water flow and steam flow into the inlets 18 and 20 respectively are adjusted as required. Extruder screws 13 and 15 are co-rotated within barrel 10 at speed to achieve an appropriate residence time and to achieve the desired cooking of the extruded product.

Extrudate from barrel 10 then proceeds through passages 44, 45, 46 and 47 which are substantially aligned with the annular extrusion flow space associated with screw 13, and through passages 48, 49, 50 and 51 which are substantially aligned with screw 15. The extrudate is then forced through die holes 62.

With this arrangement the length of the flow path of each stream of extrudate out of a die hole 62 is substantially the same when measured from the outer face of die plate 58 to a plane perpendicular to the axes of rotation of the screws 13 and 15 at the outlet ends thereof.

The cutter blades 24 cut extrudate as it is emerging from die holes 62. The faster the speed of rotation of the shafts 26 the shorter are the pieces of extrudate product 30 that are produced.

While not wishing to be bound by any particular theory, it is believed that the desirable texture of the extrudate product 30 is achieved by reducing the time during which the extrudate is not being subjected to shear by the extruder screws 13 and 15 until it emerges from the die holes 62. This effect is believed to be enhanced by the cutter blades cutting the extrudate as soon as it emerges from the die holes 62.

The cut extruded product 30 in the embodiment illustrated is allowed to expand in reduced pressure in chamber 22. The product 30 does have desirable characteristics, even when it is not extruded into a reduced pressure zone but the extrusion effect is enhanced by doing so. The pressure may be reduced to achieve the desired texture and expansion in the product produced. In a typical embodiment the pressure in chamber 22 would be reduced to a half atmospheric pressure, but other pressures may be used.

An extruded product with desirable characteristics can be produced if an extruder is operated at a location with low ambient pressure, such as an altitude well above sea level.

The pieces of cut extruded product 30 in the embodiment illustrated are allowed to tumble to neck 32 and into rotary valve 34. Rotary valve 34 discharges the products through mouth 36 where they are collected for drying, further processing or packaging.

It is desirable that the product pieces 30 are cooled to their glass transition temperature before they are allowed to collect together so as to avoid sticking. This can be achieved by allowing them to fall through a sufficient distance or by providing agitation with an air stream or by other means known to those skilled in the art. This would occur above neck 32 in chamber 22

The following examples illustrate different formulations and extrusion conditions under which the extruder and the method according to the invention may be operated.

### EXAMPLE 1

### A Crisp Extruded High Protein Breakfast Cereal

A dry mix of 45% whey protein concentrate, 15% soy protein concentrate, 10% soy protein isolate, 29.8% rice flour 0.2% calcium carbonate were fed into opening 16 of barrel 10 of the co-rotating twin screw extruder of FIGS. 1 to 9. Water and steam were introduced as needed.

The following extruder parameters were used. The extruder was started up on a higher water feed rate before reducing to the optimum feed rate for expansion of the product.

| | |
|---|---|
| Dry feed rate | 350 kg/hr |
| Water feed rate | 80 kg/hr |
| Steam feed rate | 15 kg/hr @ Atm |
| Screw speed | 235 rpm. |

The extruder temperature was recorded at 143 degrees Celsius. The extrudate passed through die holes 62 and was cut into extruded product 30 in chamber 22. The valve 31 was partially opened to vacuum source 29 to maintain the pressure in chamber 22 below ambient pressure. The extruded material 30, after discharge through rotary valve 34, was conveyed to a dryer and dried to a moisture content of about 4%.

Texture was compared in dried products produced at different pressure settings in the sealed chamber 22. A reduction in bulk density, and a preferred texture was observed with lower pressures in the sealed chamber 22.

### EXAMPLE 2

### A Whey Protein Crisp Suitable for use in Nutrition Bars, Snacks or Cereals

A dry mix of 75% whey protein concentrate, 25% rice flour were fed into opening 16 of barrel 10. Essentially the same conditions as in example 1 were employed with the exception of the extruder temperature, which reached 134 degrees Celsius.

Texture was compared in dried products produced at different pressure settings in the sealed chamber 22. A final product made at atmospheric pressure was crisp with a bulk density of 280 grams per litre. A reduction in bulk density was produced using lower pressures in the sealed chamber 22.

### EXAMPLE 3

### A Very High Protein Whey Crisp, Snack or Cereal with Very Low “Net Carb” Content

A dry mix of 68% whey protein isolate, 10% oat fiber, 10% carrot fiber, 10% oligofructose, 2% calcium carbonate were fed into opening 16 of barrel 10. Essentially the same conditions as in example 1 were employed with the exception of the extruder temperature, which reached 118 degrees Celsius.

Texture was compared in dried products produced at different pressure settings in the sealed chamber 22. Final product made at atmospheric pressure was crisp with a bulk density of 240 grams per litre. A reduction in bulk density, and a preferred texture was produced using lower pressures in the sealed chamber 22.

### EXAMPLE 4

### A Very High Protein Whey Crisp, Snack or Cereal

A dry mixture of 92% whey protein isolate, 6% rice starch, 2% calcium carbonate were fed into opening 16 of barrel 10. Essentially the same conditions as in example 1 were employed with the exception of the extruder temperature, which reached 118 degrees Celsius.

Texture was compared in dried products produced at different pressure settings in the sealed chamber 22. Final product made at atmospheric pressure was crisp with a bulk density of 250 grams per litre. A reduction in bulk density, and a preferred texture was produced using lower pressures in the sealed chamber 22.

It is not the intention to limit the scope of the invention to the abovementioned examples only. As would be appreciated by a skilled person in the art, many variations are possible without departing from the scope of the invention (as set out in the accompanying claims).

1. An extruder suitable for extruding an expanded high protein food extrudate which comprises:
a twin screw extruder having an elongate barrel with an inlet end, an outlet end and a pair of substantially frusto-cylindrical bores of substantially the same cross-sectional area therealong
a pair of flighted extrusion screws within the bores, the screws and bores defining an extrusion pathway therebetween from the inlet end to the outlet end of the barrel,
a pair of die hole sets, each set having a plurality of die holes therethrough mounted at the outlet end of the barrel, each die hole being aligned with a portion of the extrusion pathway,
the arrangement being such that the extrudate flow paths from the outlet ends of the extrusion screws to each of the outlets of end of the die holes is of substantially the same length.

2. An extruder suitable for extruding an expanded high protein food extrudate which comprises:
a twin screw extruder having an elongate barrel with an inlet end, an outlet end and a pair of substantially frusto-cylindrical bores of substantially the same cross-sectional area therealong,
a pair of flighted extrusion screws within the bores, the screws and bores defining an extrusion pathway therebetween from the inlet end to the outlet end of the barrel,
a pair of die hole sets, each set having a plurality of die holes therethrough mounted at the outlet end of the barrel, each die hole being aligned with a portion of the extrusion pathway,
the arrangement being such that the extrudate flow paths from the outlet ends of the extrusion screws to each of the outlets of end of the die holes is of substantially the same length, and
cutting means arranged to cut extrudate being extruded from the die holes into discrete pieces.

3. An extruder suitable for extruding an expanded high protein food extrudate which comprises:
a twin screw extruder having an elongate barrel with an inlet end, an outlet end and a pair of substantially frusto-cylindrical bores therealong,
a pair of flighted extrusion screws within the bores, the screws and bores defining an extrusion pathway therebetween from the inlet end to the outlet end of the barrel,
a pair of die hole sets, each set having a plurality of die holes therethrough mounted at the outlet end of the barrel, each die hole being aligned with a portion of the extrusion pathway.
the arrangement being such that the extrudate flow paths from the outlet ends of the extrusion screws to each of the outlets of end of the die holes is of substantially the same length, and a gas tight chamber at the outlet end of the barrel in gas tight communication with therewith, the gas pressure within the chamber being lower than the ambient pressure, so that extrudate extruded through the die holes is allowed to expand in the chamber.

4. An extruder as claimed in claim 1, in which the outer ends of the twin screws are substantially adjacent the outlet ends of the die holes in an axial direction.

5. An extruder as claimed in claim 1, in which there are provided cutting means arranged to cut extrudate being extruded from the die holes into discrete pieces.

6. An extruder as claimed in claim 5, in which the cutting means comprises a pair of cutting means, each one arranged to cut extrudate extruded from one of the die hole sets.

7. An extruder as claimed in claim 6, in which each of the pair of cutting means has at least one cutting blade mounted to rotate about an axis substantially co-extensive with the axis of rotation of one of the extrusion screws, and adjacent one of the die hole sets.

8. An extruder as claimed in claim 1, in which there is provided a gas tight chamber at the outlet end of the barrel in gas tight communication with therewith, the gas pressure within the chamber being lower than the ambient pressure, so that extrudate extruded through the die holes is allowed to expand in the chamber.

9. An extruder as claimed in claim 8, in which the chamber is provided with a vacuum pump to reduce the pressure therin.

10. An extruder as claimed in claim 8, in which the chamber is provided with means to discharge extrudate without substantially raising the gas pressure therein.

11. An extruder as claimed in claim 10 wherein the discharge means is a rotary valve.

12. An extruder as claimed in claim 1 in which there a provided means for keeping extrudate pieces separate from one another until they have cooled.

13. A process for extruding a high protein foodstuff which comprises feeding a dry mixture of a high protein foodstuff, water, and, where required, steam, into an extruder as defined in claim 1 at the inlet end thereof and recovering an extrudate from the outlet end thereof.

14. A process for extruding a high protein foodstuff which comprises feeding a dry mixture of high protein foodstuff, water, and, where required, steam, into an extruder as defined in claim 8 at the inlet end thereof and recovering an extrudate from the gas tight chamber.

15. An extruder as claimed in claim 2, in which the outer ends of the twin screws are substantially adjacent the outlet ends of the die holes in an axial direction.

16. An extruder as claimed in claim 2, in which the cutting means comprises a pair of cutting means, each one arranged to cut extrudate extruded from one of the die hole sets.

17. An extruder as claimed in claim 16, in which each of the pair of cutting means has at least one cutting blade mounted to rotate about an axis substantially co-extensive with the axis of rotation of one of the extrusion screws, and adjacent one of the die hole sets.

18. An extruder as claimed in claim 2, in which there is provided a gas tight chamber at the outlet end of the barrel in gas tight communication with therewith, the gas pressure within the chamber being lower than the ambient pressure, so that extrudate extruded through the die holes is allowed to expand in the chamber.

19. An extruder as claimed in claim 18, in which the chamber is provided with a vacuum pump to reduce the pressure therein.

20. An extruder as claimed in claim 18, in which the chamber is provided with means to discharge extrudate without substantially raising the gas pressure therein.

21. An extruder as claimed in claim 20, wherein the discharge means is a rotary valve.

22. An extruder as claimed in claim 2, in which there a provided means for keeping extrudate pieces separate from one another until they have cooled.

23. A process for extruding a high protein foodstuff which comprises feeding a dry mixture of a high protein foodstuff, water, and, where required, steam, into an extruder as defined in claim 2 at the inlet end thereof and recovering an extrudate from the outlet end thereof.

24. A process for extruding a high protein foodstuff which comprises feeding a dry mixture of high protein foodstuff, water, and, where required, steam, into an extruder as defined in claim 18 at the inlet end thereof and recovering an extrudate from the gas tight chamber.

25. An extruder as claimed in claim 3, in which the outer ends of the twin screws are substantially adjacent the outlet ends of the die holes in an axial direction.

26. An extruder as claimed in claim 3, in which there are provided cutting means arranged to cut extrudate being extruded from the die holes into discrete pieces.

27. An extruder as claimed in claim 26, in which the cutting means comprises a pair of cutting means, each one arranged to cut extrudate extruded from one of the die hole sets.

28. An extruder as claimed in claim 27, in which each of the pair of cutting means has at least one cutting blade mounted to rotate about an axis substantially co-extensive with the axis of rotation of one of the extrusion screws, and adjacent one of the die hole sets.

29. An extruder as claimed in claim 3, in which the chamber is provided with a vacuum pump to reduce the pressure therein.

30. An extruder as claimed in claim 29, in which the chamber is provided with means to discharge extrudate without substantially raising the gas pressure therein.

31. An extruder as claimed in claim 30, wherein the discharge means is a rotary valve.

32. An extruder as claimed in claim 3, in which there is provided means for keeping extrudate pieces separate from one another until they have cooled.

33. A process for extruding a high protein foodstuff which comprises feeding a dry mixture of high protein foodstuff, water, and, where required, steam, into an extruder as defined in claim 3 at the inlet end thereof and recovering an extrudate from the gas tight chamber.
